(19) United States
(12) Patent Application Publication
(10) Pub. No.: US 2022/0032698 A1
(43) Pub. Date: Feb. 3, 2022

(54) SWAY CONTROL BAR WITH COOLING VENTS AND SPRING CLAMP

(71) Applicant: Lippert Components, Inc., Elkhart, IN (US)

(72) Inventor: Jeffrey Paul Few, Elkhart, IN (US)

(21) Appl. No.: 17/191,423

(22) Filed: Mar. 3, 2021

Related U.S. Application Data
(60) Provisional application No. 63/057,976, filed on Jul. 29, 2020.

(51) Int. Cl. B60D 1/32

(52) U.S. Cl. CPC B60D 1/325

(57) ABSTRACT

A sway bar connectable between a towing vehicle and a towed vehicle includes a telescoping framework with an outer body and a slide bar. The outer body and slide bar include one each of a trailer connector and a tow connector. The outer body has a plurality of air vents. An air inlet opening in the telescoping framework is connected to an airflow path extending along the outer body and through the air vents. A spring clamp compresses friction pads between the outer body and the slide bar. An adjustment bolt in connection with the spring clamp is used to adjust the friction coefficient. The design allows for ventilation of the towing bar during use, which reduces the buildup of heat within the system.

### CROSS-REFERENCES TO RELATED APPLICATIONS

This application claims the benefit of U.S. Provisional Patent Application Ser. No. 63/057,976, filed Jul. 29, 2020, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to stabilizing devices and a double V-shaped spring clamp for adjusting the coefficient of friction of the sway bar and minimizing sway of a trailer relative to a towing vehicle. The invention also relates to a sway bar with cooling vents to improve sway bar functionality.

The dangers of uncontrolled sway of a towed trailer relative to a towing vehicle are apparent. In effort to minimize these dangers, sway control devices have been proposed using friction pads. Such devices, while acceptable for their intended purpose, suffer a shortcoming that wear on the friction pads may result in a deterioration in the effectiveness of the sway control, resulting in a dangerous condition. The weight of the towed vehicle, including fluctuating weight due to loading and unloading of a trailer, may also interfere with the effectiveness of the sway control. These conditions may be exacerbated by the false security stemming from the driver's belief that the sway control is operating effectively.

In previous sway bar assemblies, friction plates or clamps are utilized for engaging the sway bar in frictional engagement. These friction plates typically include two plates forming a complementary shape to the sway bar for loosely encompassing the sway bar with bolts or fasteners securing both ends of the plates together. Oftentimes, the bolts or fasteners are oriented perpendicularly to one another, which makes them difficult to work with and causes the assembly to protrude awkwardly and take up undue space. Previous friction plates or clamps lack the opportunity for adjustability in the friction coefficient between the plates and the sway bar, which causes excess wear and reduced efficiency in the sway control system.

In other sway bar assemblies such as the assembly of U.S. Pat. No. 5,222,754 to Few, friction pads are known to be used to increase the efficiency of the sway bar, but the sway bar is only engaged by two flat friction pads on opposing sides of the bar, which leaves the remaining surfaces susceptible to scraping and excess wear between components. Even further, the friction plates or clamp encompassing the friction pads and bar create a boxy shape where the assembly may only be compressed on the two opposing sides of the friction pads in an inconsistent fashion. This further leaves the components susceptible to scraping, causes a lack of control of the friction coefficient, and may create excess heat build-up within the system.

Another problem with existing devices resides in heat build-up during use, which can affect the use and functionality of the friction pads as well as the friction coefficient.

### SUMMARY

The sway bar of the described embodiments allows for ventilation of the bar during use, which reduces the buildup of heat within the system, resulting in a more efficient and consistent sway control system. The sway bar of the described embodiments also allows for adjustment of the coefficient of friction of the sway bar via a spring clamp and associated adjustment bolt, which also results in a more efficient and adaptable sway control system. Features of the design include friction pads that create air pathways within the double V-shaped main body of the system, air vents built into the main body of the system for relieving heat, and a double V-shaped spring clamp with an adjustment bolt on one end and a cam handle on the other end for controlling the coefficient of friction.

In an exemplary embodiment, a sway bar connectable between a towing vehicle and a towed vehicle includes a double V-shaped outer body with a trailer connector at one end and a receptacle at an opposite end. The outer body is provided with air vents. A slide bar includes a bar body positioned in the receptacle of the outer body and a tow connector at a distal end. The bar body is displaceable telescopically relative to the outer body. A plurality of friction pads are interposed between the double V-shaped outer body and the bar body, and a double V-shaped spring clamp is secured over the double V-shaped outer body. The double V-shaped spring clamp compresses the double V-shaped outer body and defines a friction coefficient between the slide bar and the friction pads. An air inlet opening between the slide bar and the double V-shaped outer body is connected to an airflow path extending along the double V-shaped outer body and through the air vents.

The air inlet opening may be disposed in the receptacle of the double V-shaped outer body. The double V-shaped outer body may include two right-angle angle irons defining an essentially square cross section with four interior walls, and the sway bar may include four friction pads, one each secured to each of the four interior walls. The four friction pads may form one or more V-shapes with the double V-shaped outer body. The bar body of the slide bar may be square in cross section including four sides, where each of the four sides may be engaged with one of the four friction pads. The sway bar may include four air inlet openings, one each at each corner of the outer body essentially square cross section. The double V-shaped outer body may define four exterior walls, where each of the four exterior walls includes the air vents.

The friction pads may be fixed to interior walls of the double V-shaped outer body. Each of the friction pads may be secured on a base plate, and the friction pads and base plates may be secured to the double V-shaped outer body via connectors extending through the friction pads and the base plates.

The double V-shaped spring clamp may include a fixed bracket and a spring plate together sandwiching the double V-shaped outer body. The fixed bracket may include a first cam tab and a first bolt tab, and the spring plate may include a second cam tab and a second bolt tab. The first and second cam tabs may be connected, and the first and second bolt tabs may be connected. The sway bar may further include a cam handle mechanism extending through the connected first and second cam tabs that is configured to separate the second cam tab from the first cam tab. The sway bar may additionally include an adjustment bolt extending through the first and a second bolt tabs that is configured to adjust the friction coefficient between the slide bar and the friction pads.

In another exemplary embodiment, a sway bar connectable between a towing vehicle and a towed vehicle includes a telescoping framework with a double V-shaped outer body including one of a trailer connector and a tow connector and a slide bar displaceable relative to the double V-shaped outer body and including the other of the trailer connector and the tow connector, a plurality of air vents in the double V-shaped outer body, and an air inlet opening in the telescoping framework. The air inlet opening is connected to an airflow path extending along the double V-shaped outer body and through the air vents.

In yet another exemplary embodiment, a sway bar connectable between a towing vehicle and a towed vehicle includes a telescoping framework with an outer body including one of a trailer connector and a tow connector and a slide bar displaceable relative to the outer body and including the other of the trailer connector and the tow connector, friction pads positioned between the outer body and the slide bar, and a spring clamp secured over the outer body. The spring clamp compresses the outer body and defines a friction coefficient between the slide bar and the friction pads. An adjustment bolt cooperable with the spring clamp is configured to adjust the friction coefficient between the slide bar and the friction pads.

### BRIEF DESCRIPTION OF THE DRAWINGS

These and other aspects and advantages will be described in detail with reference to the accompanying drawings, in which:

FIG. 1 is a perspective view of a sway control bar including cooling vents and a spring clamp;

FIG. 2 is a side view thereof; and

FIG. 3 is a cross-sectional view through the spring clamp and double V-shaped body of the system.

### DETAILED DESCRIPTION

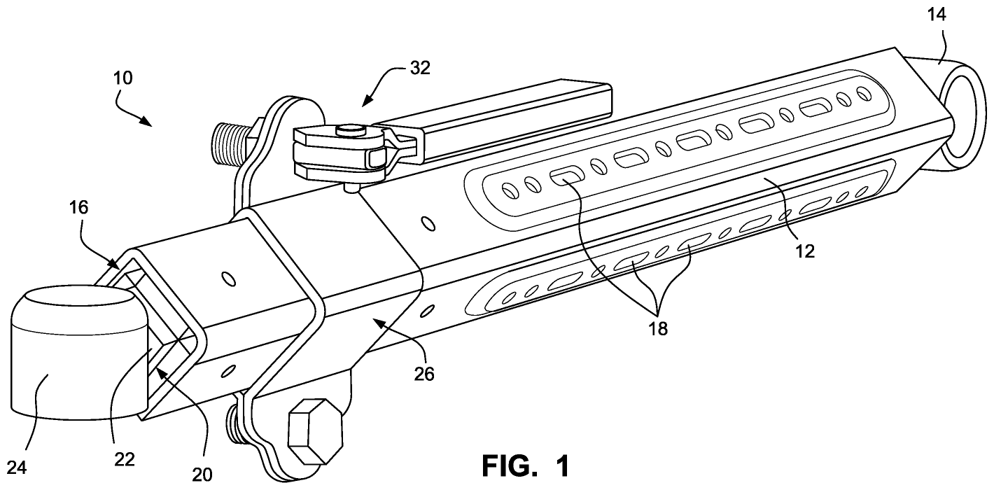

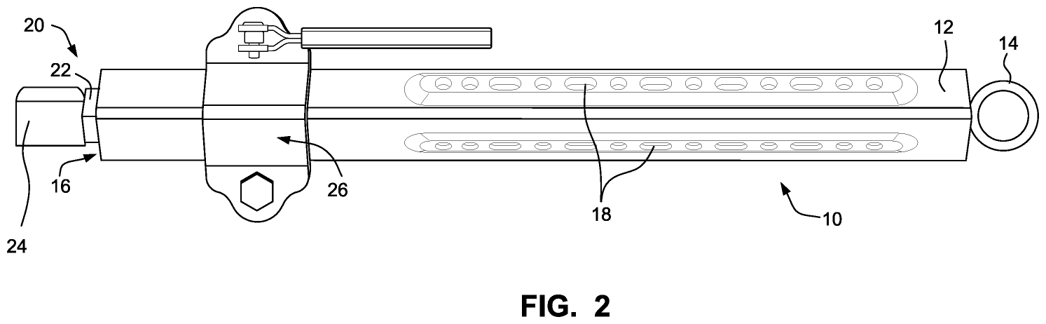

FIGS. 1 and 2 show a sway bar 10 connectable between a towing vehicle and a towed vehicle. The sway bar 10 includes a telescopic framework with an outer body 12 including a trailer connector 14 at one end and a receptacle 16 at an opposite end. The outer body 12 also includes a plurality of air vents 18. In some embodiments, the outer body is double V-shaped or diamond shaped as shown.

A slide bar 20 is positioned in the receptacle 16 of the outer body 12. The slide bar 20 includes a bar body 22 positioned in the receptacle 16 and displaceable telescopically relative to the outer body 12 and a tow connector 24 at a distal end. In some embodiments, the tow connector 24 is connectable to a towing vehicle, for example adjacent a trailer hitch or the like, and the trailer connector 14 is connectable to a towed vehicle, for example on a trailer frame. Of course, alternative connectors could be used and/or the connectors could be reversed.

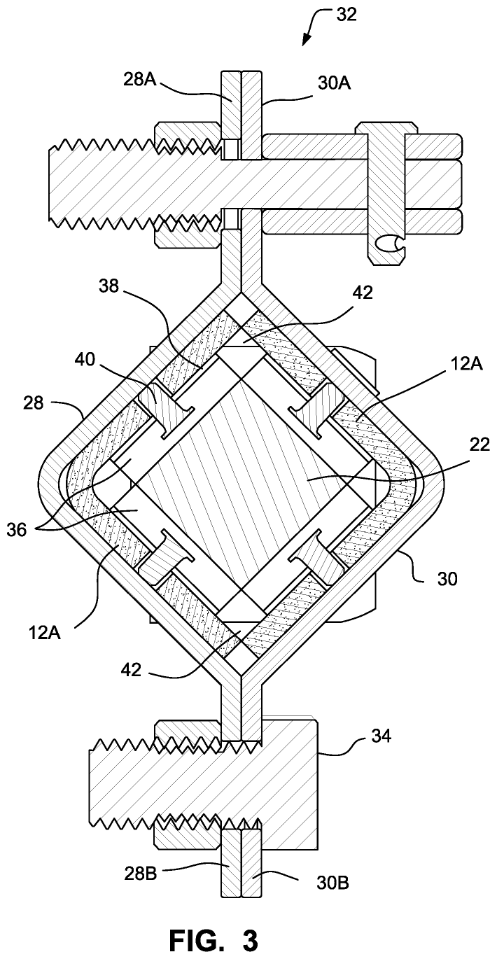

A spring clamp 26 is secured over the outer body 12. In some embodiments, the spring clamp is double V-shaped in complement to the outer body 12. With reference to FIG. 3, the outer body 12 is generally comprised of two right-angle angle irons 12A defining an essentially square cross-section with four interior walls. The spring clamp 26 includes a fixed V-shaped bracket 28 and a corresponding spring plate 30 together sandwiching the double V-shaped outer body 12. The double V-shaped spring clamp 26 serves to compress the double V-shaped outer body 12, providing consistent and equal compression on all four sides of the double V-shaped body. The right-angle angle irons 12A of the outer body 12 may include the air vents 18 in each of four exterior walls of the outer body 12.

The V-shaped fixed bracket 28 includes a first cam tab 28A and a first bolt tab 28B, and the spring plate 30 includes a second cam tab 30A and a second bolt tab 30B. The first 28A and second 30A cam tabs are secured in facing relation via a cam handle assembly 32, and the first 28B and second 30B bolt tabs are secured in facing relation via an adjustment bolt 34.

A plurality of friction pads 36 are interposed between the double V-shaped outer body 12 and the bar body 22 of the slide bar 20. In some embodiments, the sway bar includes four friction pads 36, one secured to each of the four interior walls of the outer body 12. Each of the friction pads 36 may be secured on a base plate 38, where the friction pads 36 and base plates 38 are secured to the outer body 12 via connectors 40 extending through the friction pads 36 and the base plates 38. In some embodiments, the connectors 40 may be rivets or the like countersunk into the friction pads 36 and extending through the base plate 38 and the walls of the double V-shaped outer body 12.

The bar body 22 of the slide bar 20 is generally square in cross-section including four sides. As shown in FIG. 3, each of the four sides is engaged with one of the friction pads 36. The friction pads 36 form V-shapes within the double V-shaped outer body 12, subsequently contacting each surface of both the bar body 22 and the interior of the double V-shaped outer body 12 for increased control of the friction coefficient. The friction pads 36 are generally sized corresponding to the size of the bar body 22 thereby leaving open spaces at each corner of the essentially square cross-section of the outer body 12. These open spaces define air inlet openings in the receptacle 16 of the outer body 12 between the slide bar 20 and the outer body 12. The air inlet openings 42 extend along a length of the outer body 12 to define an air flow path through the outer body 12. The air flow path extends along the outer body 12 and cooperates with the air vents 18 of the outer body 12.

By using components with a square cross-section and orienting the friction pads on opposite sides to define the air inlet openings, airflow paths or venting channels are created that serve to reduce and manage heat build-up at the friction pads/slide bar interface. The longitudinal air vents in the outer body aid in controlling heat build-up, thereby maintaining the set friction coefficient.

The cam handle assembly/mechanism 32 extends through the first 28A and second 30A cam tabs. The cam handle assembly 32 is configured to separate the second cam tab 30A from the first cam tab 28A in a release position. Preferably, the cam handle 32 is only used at installation of the sway bar. In the embodiments shown, the spring clamp 26 compresses the right-angle angle irons 12A including fastened friction pads 36 and base plates 38 with the slide bar 20 to hold the assembly together. With the adjustment bolt 34 securing the bottom of the double V-shaped spring clamp 26 and the cam handle 32 in the release position, the slide bar 20 may be telescopically adjusted to the proper length for securing trailer connector 14 to the towed vehicle and tow connector 24 to the towing vehicle. Once the connectors are secured and the sway bar 10 is installed, the cam handle 32 is rotated to a lock position to secure the first cam tab 28A and the second cam tab 30A to lock the sway bar assembly in place. Preferably, the cam handle 32 remains in the locked position unless disassembly of the sway bar is necessary.

As mentioned above, the spring clamp 26 includes a fixed V-shaped bracket 28 and a corresponding spring plate 30 that together compress the double V-shaped outer body 12. The fixed V-shaped bracket 28 and the spring plate 30 create a double V-shape or diamond that is nearly identical to the outer body 12 and overall sway bar 10, which increases compressibility of the system and therefore optimizes the ability to adjust the friction coefficient. The increased compressibility between the double V-shaped spring clamp 26 and the outer body 12 with the friction pads 36 requires less compression pressure on the sway bar 10, and therefore can use lighter materials and reduce overall weight. The first cam tab 28A and the second cam tab 30A extend in a direction parallel to the first bolt tab 28B and the second bolt tab 30B. In the embodiments shown, the first and second cam tabs 28A, 30A are linear to the first and second bolt tabs 28B, 30B. The parallel tabs create a cleaner appearance and simplify installation of the sway bar. The spring clamp 26 provides better adjustability of the friction coefficient via the adjustment bolt 34, as will be described in more detail below.

The adjustment bolt 34 provides for adjusting a friction coefficient between the slide bar 22 and the friction pads 36. Similar to the cam handle 32, the adjustment bolt 34 is preferably not completely removed from the double V-shaped spring clamp 26 for the purpose of holding the sway bar assembly together. The adjustment bolt 34 is used to increase or decrease the distance between the first and second bolt tabs 28B, 30B to adjust the friction coefficient, but the tabs are preferably not fastened together to be touching at the risk of eliminating all suspension within the sway bar. The friction coefficient is set by using a force gauge, reading tension and compression then setting the specified force with the adjustment bolt 34. The spring plate 30 is engineered to apply a force at the cam handle assembly 32 and adjustment bolt 34, preventing both the handle and cam lock of the cam handle assembly from loosening. The double V-shaped spring clamp 26 compresses the angle irons 12A of the outer body 12 to define the friction coefficient between the slide bar 20 and the V-shaped friction pads 36.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A sway bar connectable between a towing vehicle and a towed vehicle, the sway bar comprising:
a double V-shaped outer body including a trailer connector at one end and a receptacle at an opposite end, the outer body including air vents;
a slide bar including a bar body positioned in the receptacle of the outer body and a tow connector at a distal end, the bar body being displaceable telescopically relative to the outer body;
a plurality of friction pads interposed between the double V-shaped outer body and the bar body;
a double V-shaped spring clamp secured over the double V-shaped outer body, the double V-shaped spring clamp compressing the double V-shaped outer body and defining a friction coefficient between the slide bar and the friction pads; and
an air inlet opening between the slide bar and the double V-shaped outer body, the air inlet opening connected to an airflow path extending along the double V-shaped outer body and through the air vents.

2. A sway bar according to claim 1, wherein the air inlet opening is disposed in the receptacle of the double V-shaped outer body.

3. A sway bar according to claim 1, wherein the double V-shaped outer body comprises two right-angle angle irons defining an essentially square cross section with four interior walls, and wherein the sway bar comprises four friction pads, one each secured to each of the four interior walls.

4. A sway bar according to claim 3, wherein the four friction pads form one or more V-shapes with the double V-shaped outer body.

5. A sway bar according to claim 3, wherein the bar body of the slide bar is square in cross section including four sides, and wherein each of the four sides is engaged with one of the four friction pads.

6. A sway bar according to claim 3, comprising four air inlet openings, one each at each corner of the outer body essentially square cross section.

7. A sway bar according to claim 6, wherein the double V-shaped outer body defines four exterior walls, and wherein each of the four exterior walls includes the air vents.

8. A sway bar according to claim 1, wherein the friction pads are fixed to interior walls of the double V-shaped outer body.

9. A sway bar according to claim 8, wherein each of the friction pads is secured on a base plate, and wherein the friction pads and base plates are secured to the double V-shaped outer body via connectors extending through the friction pads and the base plates.

10. A sway bar according to claim 1, wherein the double V-shaped spring clamp comprises a fixed bracket and a spring plate together sandwiching the double V-shaped outer body, the fixed bracket including a first cam tab and a first bolt tab, and the spring plate including a second cam tab and a second bolt tab, wherein the first and second cam tabs are connected, and wherein the first and second bolt tabs are connected.

11. A sway bar according to claim 10, further comprising a cam handle mechanism extending through the connected first and second cam tabs, the cam handle mechanism being configured to separate the second cam tab from the first cam tab.

12. A sway bar according to claim 10, further comprising an adjustment bolt extending through the first and a second bolt tabs, the adjustment bolt being configured to adjust the friction coefficient between the slide bar and the friction pads.

13. A sway bar connectable between a towing vehicle and a towed vehicle, the sway bar comprising:
a telescoping framework with a double V-shaped outer body including one of a trailer connector and a tow connector and a slide bar displaceable relative to the double V-shaped outer body and including the other of the trailer connector and the tow connector;
a plurality of air vents in the double V-shaped outer body; and
an air inlet opening in the telescoping framework, the air inlet opening connected to an airflow path extending along the double V-shaped outer body and through the air vents.

14. A sway bar according to claim 13, wherein the double V-shaped outer body comprises two right-angle angle irons defining an essentially square cross section with four interior walls, the sway bar comprising four air inlet openings, one each at each corner of the double V-shaped outer body essentially square cross section.

15. A sway bar according to claim 14, wherein the double V-shaped outer body defines four exterior walls, and wherein each of the four exterior walls includes the air vents.

16. A sway bar according to claim 13, further comprising friction pads positioned between the double V-shaped outer body and the slide bar.

17. A sway bar according to claim 16, further comprising a double V-shaped spring clamp secured over the double V-shaped outer body, the double V-shaped spring clamp compressing the double V-shaped outer body and defining a friction coefficient between the slide bar and the friction pads.

18. A sway bar according to claim 17, wherein the double V-shaped spring clamp comprises a fixed bracket and a spring plate together sandwiching the double V-shaped outer body, the fixed bracket including a first cam tab and a first bolt tab, and the spring plate including a second cam tab and a second bolt tab, wherein the first and second cam tabs are connected, and wherein the first and second bolt tabs are connected.

19. A sway bar connectable between a towing vehicle and a towed vehicle, the sway bar comprising:
a telescoping framework with an outer body including one of a trailer connector and a tow connector and a slide bar displaceable relative to the outer body and including the other of the trailer connector and the tow connector;
friction pads positioned between the outer body and the slide bar;
a spring clamp secured over the outer body, the spring clamp compressing the outer body and defining a friction coefficient between the slide bar and the friction pads; and
an adjustment bolt cooperable with the spring clamp configured to adjust the friction coefficient between the slide bar and the friction pads.

20. A sway bar according to claim 19, wherein the outer body is double V-shaped, and wherein the spring clamp is double V-shaped.
